(19) United States
(12) Patent Application Publication
(10) Pub. No.: US 2009/0141035 A1
(43) Pub. Date: Jun. 4, 2009

(54) DISPLAY CONTROL APPARATUS AND IMAGE FORMING APPARATUS EMPLOYING SAME

(75) Inventors: Hirotaka Kodama, Nara (JP); Hirohito Morioka, Nara (JP); Mikiya Okada, Nara (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/277,783

(22) Filed: Nov. 25, 2008

(30) Foreign Application Priority Data
Nov. 27, 2007 (JP) 2007-305991

(51) Int. Cl. G06T 1/60

(52) U.S. Cl. 345/530

(57) ABSTRACT

In one embodiment of the present invention, in a display control apparatus that repeatedly displays various image data on a screen, the display control apparatus includes: an input/setting means that, for each unit of image data, inputs/sets an image data display control method corresponding to a number of display times of the image data; a storage means that, for each unit of image data, stores the image data display control method corresponding to the number of display times of the image data that has been input/set by the input/setting means; and a control means that, when repeatedly displaying image data, identifies the number of display times of the image data, and displays the image data according to the image data display control method corresponding to the number of display times that has been stored in the storage means.

### BACKGROUND OF THE INVENTION

This application claims priority under 35 U.S.C. § 119(a) on Japanese Patent Application No. 2007-305991 filed in Japan on Nov. 27, 2007, the entire contents of which are herein incorporated by reference.

The present invention relates to a display control apparatus that repeatedly displays various image data on a screen, and an image forming apparatus employing that display control apparatus.

In a device such as a copy machine or a facsimile apparatus provided in a store such as a convenience store, a display screen is provided, and an operating method or the like of the device is displayed on this display screen.

However, ordinarily, while the device is in standby, the display content of the display screen remains set to fixed content, so there is room to enlarge the scope of use of the display screen. Also, while the device is in operation, the operating method or the like of the device is displayed, but because this display is performed with only still images, it is not easily understood by a user who is viewing the display screen.

Therefore, it is conceivable to display the operating method or the like of the device with a movie, but movie playback takes time, and a long time is consumed by repeatedly displaying a movie to insure understanding of the operating method.

On the other hand, JP H11-32304A discloses technology that, by operation of a mouse or the like, makes it possible to easily adjust and set the playback speed of a movie displayed on a display screen. By adopting the technology described in JP H11-32304A, it is possible to easily adjust the playback speed of a movie, and thus it is possible to shorten the movie playback time.

Also, JP 2005-45574A discloses technology for editing a movie into a digest. By adopting the technology described in JP 2005-45574A, it is possible to display only main places from the beginning to the end of the movie, ultimately shortening the movie playback time.

However, even if it is possible to easily adjust the playback speed of a movie as with the technology described in JP H11-32304A, a first-time user of the device does not know which places in the movie are important, so ease of use is not good.

Also, in the case of editing a movie into a digest as with the technology described in JP 2005-45574A, because only main places from the beginning to the end of the movie are displayed, important places in the movie are not displayed in detail, so ease of use is not good.

### SUMMARY OF THE INVENTION

The present invention was made in view of the above problems in the conventional technology, and it is an object of the invention to provide a display control apparatus that is capable of repeatedly displaying a movie of an operating method or the like of a device in a more easily understood manner and for a shorter time, and an image forming apparatus employing that display control apparatus.

In order to address the above problems, the invention is directed to a display control apparatus that repeatedly displays various image data on a screen, the display control apparatus including: an input/setting means that, for each unit of image data, inputs/sets an image data display control method corresponding to a number of display times of the image data; a storage means that, for each unit of image data, stores the image data display control method corresponding to the number of display times of the image data that has been input/set by the input/setting means; and a control means that, when repeatedly displaying image data, identifies the number of display times of the image data, and displays the image data according to the image data display control method corresponding to the number of display times that has been stored in the storage means.

The image data expresses a movie.

Furthermore, the image data expresses a plurality of still images that are displayed by sequentially switching.

Also, the display control method adjusts an image data playback speed.

Furthermore, the display control method sets non-display of image data.

Also, the display control apparatus is applied to a device, and the control means, while the device is in standby, performs display of image data with an image data display control method according to the number of display times.

Furthermore, the display control apparatus is applied to a device, and the control means, during operation of the device, performs display of image data with an image data display control method according to the number of display times.

Also, the display control apparatus is applied to a device, and the image data is any of an explanation of a function of the device and an advertising image.

On the other hand, the image forming apparatus of the invention employs the above display control apparatus of the invention.

According to this sort of display control apparatus of the invention, when repeatedly displaying various image data on a screen, the number of display times of the image data is identified, and the image data is displayed according to the image data display control method corresponding to this number of display times. The image data may be a movie or may be a plurality of still images that are displayed by sequentially switching, and the content of the image data does not matter. For example, image data playback speed is adjusted, or non-display of image data is set, according to the number of display times. Thus, during the first time of display, playback of the image data is performed at a normal playback speed, and during the second and subsequent times of display, playback of the image data is performed at fast playback speed, non-display of the image data is set, only necessary places in a movie or a plurality of still images are quickly displayed, or non-display of unnecessary places is set, and therefore it is possible to improve usability while shortening the playback time.

Also, while the device in which the display control apparatus has been applied is in standby, it is possible to repeatedly display new functions of the device, various advertisements, and the like, and by switching the display control method of these displays, it is possible to increase the appeal of the display content.

Furthermore, during operation of the device in which the display control apparatus has been applied, it is possible to repeatedly display the operating method of the device, and by switching the display control method of that display, it is possible for the operating method to be quickly understood. For example, during the first time of display, playback of the image data is performed at a normal playback speed, and during the second and subsequent times of display, only necessary places are displayed at slow speed, or non-display of unnecessary places is set.

Also, it is conceivable that the image data is an explanation of a function of the device, an advertising image, or the like.

On the other hand, the image forming apparatus of the invention employs the above display control apparatus of the invention, and so the image forming apparatus of the invention exhibits the same working effects as the display control apparatus of the invention.

### BRIEF DESCRIPTION OF THE DRAWINGS

FIG. 1 shows a block diagram of one embodiment of a display control apparatus of the invention.

FIG. 2 shows an example of a display control method settings screen in the display control apparatus of FIG. 1.

FIG. 3 is a flowchart that shows a display control procedure of a first time, second time, and subsequent times according to the display control apparatus of FIG. 1.

FIG. 4A is a timing chart of movies that have been played back in an ordinary sequence and with an ordinary playback speed, and FIG. 4B is a timing chart of movies that have been played back according to respective display control methods.

### DESCRIPTION OF THE PREFERRED EMBODIMENTS

Hereinafter, embodiments of a display control apparatus of the present invention will be described in detail.

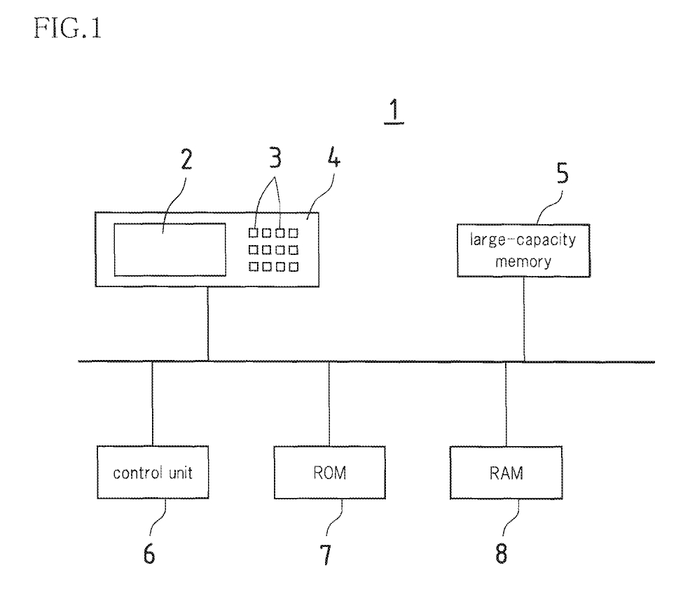

FIG. 1 shows a block diagram of one embodiment of a display control apparatus of the invention. A display control apparatus 1 of this embodiment is installed in a multifunction image forming apparatus that is provided in a store such as a convenience store and has a copy function, a facsimile function, and the like, the display control apparatus 1 being used mainly for displaying an operating method of the multifunction image forming apparatus.

The display control apparatus 1 of this embodiment is provided with an operating panel 4 that has a liquid crystal display apparatus 2 and a plurality of operating keys 3, a large-capacity memory 5 in which a plurality of units of image data have been stored, a control unit 6 configured from a CPU, an interface, and the like, a ROM 7 in which programs, data and the like related to display control have been stored, and a RAM 8 used for temporary opening or the like of programs. The control unit 6 reads a program from the ROM 7 in response to an input operation of the operating panel 4, opens the program in the RAM 8 and executes the program, reads image data from the large-capacity memory 5, and performs playback of a movie or the like expressed by the image data to display the movie on a screen of the liquid crystal display apparatus 2 of the operating panel 4.

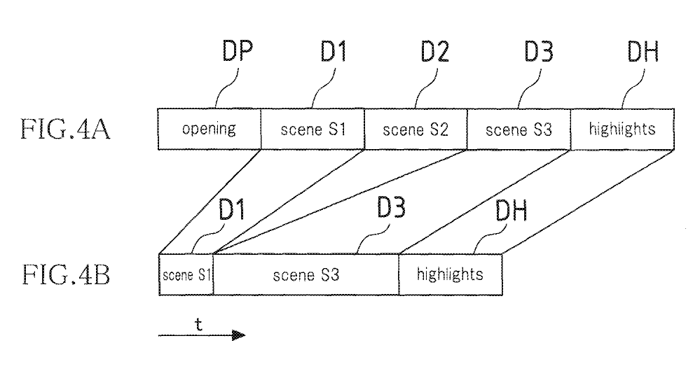

The image data in the large-capacity memory 5, for example, expresses a movie of an operating method of the multifunction image forming apparatus, and as shown in FIG. 4A, is comprised of image data DP that expresses a movie of an opening, image data D1 that expresses a movie of a scene S1, image data D2 that expresses a movie of a scene S2, image data D3 that expresses a movie of a scene S3, and image data DH that expresses a movie of highlights. By sequentially performing playback and display of the respective movies expressed by these units of image data DP, D1 to D3, and DH, playback of all movies of the operating method of the multifunction image forming apparatus is performed.

Ater performing playback of one complete sequence of all movies of the operating method of the multifunction image forming apparatus, rather than repeating the same playback, performing repeated playback of only important places, and not displaying places that are unimportant, allows the operating method to be more easily understood by the user and saves time.

Consequently, in this embodiment, when repeatedly displaying each unit of image data DP, D1 to D3, and DH, for the second and subsequent times of display, it is made possible to change the image data display control method separately for each unit of image data DP, D1 to D3, and DH.

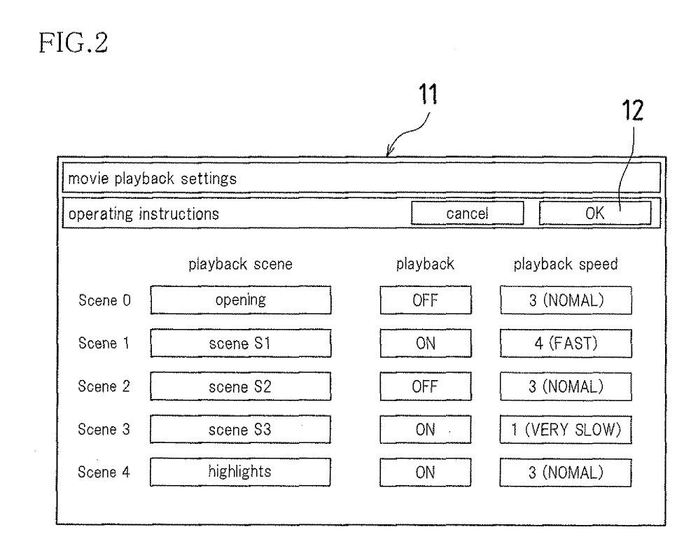

In order to change the display control method for the second and subsequent times of display, it is necessary set the display control method for the second and subsequent times of display in advance. Here, when an input operation of the operating keys 3 of the operating panel 4 is performed to instruct settings of the display control method, a settings screen 11 as shown in FIG. 2 is displayed on the screen of the liquid crystal display apparatus 2 of the operating panel 4 by the control unit 6, so by an input operation of the operating keys 3, separately for each unit of image data, the display control method for the second and subsequent times of display is entered in the settings screen 11 and thus set. This operation is performed by a staff member, manager, or the like of the store.

In the settings screen 1 in FIG. 2, there are the items opening, scene S1, scene S2, scene S3, and highlights corresponding to the respective units of image data DP, D1 to D3, and DH, and separately for each item, it is possible to enter and set whether or not to perform playback of image data, and the playback speed of image data. For example, with respect to the opening of the image data DP, “OFF” is entered to indicate non-playback, and thus the playback speed is inactivated, so the display of playback speed is shaded. Also, with respect to scene S1 of the image data D1, “ON” is entered to indicate playback, and “4 (FAST)” is entered to indicate a fast playback speed. Likewise, with respect to scene S2 of the image data D2, “OFF” is entered to indicate non-playback, and thus the playback speed is inactivated, and with respect to scene S3 of the image data D3, “ON” is entered to indicate playback, and “1 (VERY SLOW)” is entered to indicate a very slow playback speed. Further, with respect to highlights of the image data DH, “ON” is entered to indicate playback, and “3 (NORMAL)” is entered to indicate a normal playback speed. Note that “2 (SLOW)” and “5 (VERY FAST)” can also be set as other playback speeds, so five levels of playback speed can be set.

After entering the display control method for the second and subsequent times of display in the settings screen 11 separately for each unit of image data in this manner, when an OK button 12 of the setting screen 11 is instructed using an input operation of the operating keys 3, the control unit 6, in response to that instruction, stores the display control method for the second and subsequent times of display of each unit of image data that has been set on the settings screen 11 in the ROM 7, and closes the settings screen 11.

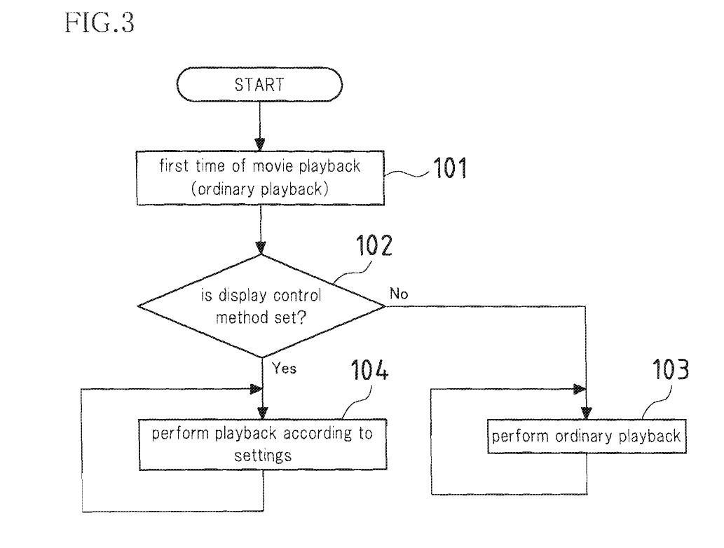

Next is a description of a display control procedure performed by the display control apparatus 1 in a first time and second and subsequent times, according to the flowchart in FIG. 3.

First, during operation of the multifunction image forming apparatus, when display of the operating method of the multifunction image forming apparatus is instructed by an input operation of the operating keys 3, the control unit 6 sequentially reads each unit of image data DP, D1 to D3, and DH from the large-capacity memory 5, and sequentially displays the opening movie, the scene S1 movie, the scene S2 movie, the scene S3 movie, and the highlights movie expressed by these units of image data DP, D1 to D3, and DH, on the screen of the liquid crystal display apparatus 2 at an ordinary playback speed (Step 101).

Accordingly, the opening movie, the scene S1 movie, the scene S2 movie, the scene S3 movie, and the highlights movie are sequentially displayed with passage of a time t and at an ordinary playback speed, as shown in FIG. 4A.

When one iteration of playback of each of the units of image data DP, D1 to D3, and DH ends, the control unit 6 searches the ROM 7 and determines whether or not a display control method for second and subsequent times of display of each unit of image data has been set (Step 102). At this time, if a display control method for second and subsequent times of display of each unit of image data has not been set (“No” in Step 102), then the control unit 6 again sequentially reads each unit of image data DP, D1 to D3, and DH from the large capacity memory 5, sequentially performs playback to display the opening movie, the scene S1 movie, the scene S2 movie, the scene S3 movie, and the highlights movie at ordinary speed as shown in FIG. 4A (Step 104), and thereafter, repeats sequential display of each movie in the same manner, as shown in FIG. 4A.

If a display control method for second and subsequent times of display of each unit of image data has been set (“Yes” in Step 102), then the control unit 6, for each unit of image data, referring to the display control method for second and subsequent times of display in the ROM 7, displays the movie expressed by the image data using this display control method (Step 103). Here, because the opening of the image data DP is set to “OFF”, indicating non-playback, the movie expressed by the image data DP is not played back, and because “ON” and “4(FAST)” are set for scene S1 of the image data D1, indicating playback and a fast playback speed, the movie expressed by the image data D1 is played back at a fast playback speed, and because scene S2 of the image data S2 is set to “OFF”, indicating non-playback, the movie expressed by the image data S2 is not played back, and because “ON” and “1(VERY SLOW)” are set for scene S3 of the image data D3, indicating playback and a very slow playback speed, the movie expressed by the image data D3 is played back at a very slow playback speed, and because “ON” and “3(NORMAL)” are set for the highlights of the image data DH, indicating playback and a normal playback speed, the movie expressed by the image data DH is played back at a normal playback speed.

Accordingly, as shown in FIG. 4B, the scene S1 movie is displayed at fast speed, the scene S3 movie is displayed at slow speed, the highlights movie is displayed at normal speed, and the opening movie and the scene 2 movie are not displayed.

The control unit 6 subsequently repeats sequential display of each movie as shown in FIG. 4B, until instructed to stop display of the operating method by an input operation of the operating keys 3.

In this way, in the present embodiment, when displaying the operating method of the multifunction image forming apparatus, in the first time of display, playback of one complete sequence of all of the movies is performed at normal speed, and in the second and subsequent times of display, separately for each movie, playback is performed, not performed, or the playback speed is changed to a speed different from that during the first time of display. For example, because the importance of the opening movie and the scene S2 movie is very low, playback of these movies is not performed, and because the importance of the scene S1 movie is low, playback of this movie is performed at high speed, and because the importance of the scene S3 movie is high, playback of this movie is performed at slow speed, and because the importance of the highlights movie is normal, playback of this movie is performed at normal speed. Thus, the operating method is easily understood by the user, and time is saved.

Note that here, movies that express the operating method of the multifunction image forming apparatus are displayed, but a configuration may also be adopted in which, while the multifunction image forming apparatus is in standby, movies that indicate new or convenient functions of this apparatus, store advertisements, and the like are sequentially displayed, and with respect to these movies, the settings for the display control method for the second and subsequent times of display are changed.

Also, image data may be used that expresses not movies, but rather a series of a plurality of still images. In this case, a configuration may be adopted in which the series of still images is sequentially displayed, and instead of changing movie playback speed, a display time interval for each still image is changed.

Furthermore, the display control method may be changed at each display time as the number of display times increases, such as at the second time, the third time, and so on. An audio playback control method may also be changed, based on the display control method. For example, separately for the audio of each movie, audio playback is performed, not performed, or the audio playback speed is changed to a speed different from that during the first time of playback.

The display apparatus of the present invention is applicable not only in an image forming apparatus, but also in other devices, such as an ATM, and is applicable regardless of the display content of the device.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. A display control apparatus that repeatedly displays various image data on a screen, the display control apparatus comprising:
an input/setting means that, for each unit of image data, inputs/sets an image data display control method corresponding to a number of display times of the image data;
a storage means that, for each unit of image data, stores the image data display control method corresponding to the number of display times of the image data that has been input/set by the input/setting means; and
a control means that, when repeatedly displaying image data, identifies the number of display times of the image data, and displays the image data according to the image data display control method corresponding to the number of display times that has been stored in the storage means.

2. The display control apparatus according to claim 1, wherein the image data expresses a movie.

3. The display control apparatus according to claim 1, wherein the image data expresses a plurality of still images that are displayed by sequentially switching.

4. The display control apparatus according to claim 1, wherein the display control method adjusts an image data playback speed.

5. The display control apparatus according to claim 1, wherein the display control method sets non-display of image data.

6. The display control apparatus according to claim 1,
wherein the display control apparatus is applied to a device, and
the control means, while the device is in standby, performs display of image data with an image data display control method according to the number of display times.

7. The display control apparatus according to claim 1,
wherein the display control apparatus is applied to a device, and
the control means, during operation of the device, performs display of image data with an image data display control method according to the number of display times.

8. The display control apparatus according to claim 1,
wherein the display control apparatus is applied to a device, and
the image data is any of an explanation of a function of the device and an advertising image.

9. An image forming apparatus employing the display control apparatus according to any one of claims 1 to 8.
